(19) United States
(12) Patent Application Publication
(10) Pub. No.: US 2024/0393890 A1
(43) Pub. Date: Nov. 28, 2024

(54) SECURE PERIPHERAL SHARING DEVICE

(71) Applicant: BAE SYSTEMS Information and Electronic Systems Integration Inc., Nashua, NH (US)

(72) Inventors: Mark E. Leibowitz, Ronkonkoma, NY (US); Edwin W. Drewitz, JR., East Northport, NY (US); Saeed Karamooz, Henerson, NV (US); Jon P. Schweikert, West Sayville, NY (US); William F. Aversano, East Northport, NY (US); Susan J. Klavir, Greenlawn, NY (US)

(73) Assignee: BAE SYSTEMS Information and Electronic Systems Integration Inc., Nashua, NH (US)

(21) Appl. No.: 18/323,675

(22) Filed: May 25, 2023

(51) Int. Cl. G06F 3/14; G06F 3/023; H04Q 11/00

(52) U.S. Cl. CPC G06F 3/023; H04Q 11/0005; H04Q 2011/0016; H04Q 2213/003

(57) ABSTRACT

A peripheral sharing device includes an optical switch, a first signal interface, and a plurality of second signal interfaces. The first signal interface is coupled to the optical switch via a first optical fiber cable. The first signal interface is configured to be coupled to at least one peripheral device, such as a keyboard, pointing device, or video display. A first one of the second signal interfaces is coupled to the optical switch via a second optical fiber cable. A second one of the second signal interfaces is coupled to the optical switch via a third optical fiber cable. The first one of the second signal interfaces is configured to be coupled to a first computing device, and the second one of the second signal interfaces is configured to be coupled to a second computing device.

### STATEMENT OF GOVERNMENT INTEREST

This invention was made with government support under sub-contract number 1732934 awarded by the United States Navy. The government has certain rights in the invention.

### FIELD OF DISCLOSURE

The present disclosure relates to computer peripherals, and more particularly, to secure peripheral sharing devices.

### BACKGROUND

A peripheral sharing device is a device that allows multiple computers to share use of one or more peripherals, such as keyboards, pointing devices (e.g., a computer mouse, a trackpad, a trackball, a stylus, etc.), display monitors, printers, card readers, and other types of input and output devices that are used in conjunction with each of the computers. For example, the peripheral sharing device can include a switch or set of switches that connect the peripherals to one computer at a time. When a user wishes to use a different computer, the switch connects the peripherals to that other computer so that inputs are available to that computer and outputs from that computer are available to the user. Such peripheral sharing devices are useful, for example, in scenarios where multiple computers are in use but inadequate working space exists for installing separate peripherals for each of the computers, or to reduce hardware costs associated with operating a multi-computer workstation.

### BRIEF DESCRIPTION OF THE DRAWINGS

FIG. 1 is a block diagram of a peripheral switching device, in accordance with an example of the present disclosure.

FIG. 2 is a block diagram of the peripheral switching device of FIG. 1 in further detail, in accordance with an example of the present disclosure.

FIGS. 3A and 3B are each block diagrams of the peripheral switching device of FIGS. 1 and 2 in further detail, in accordance with an example of the present disclosure.

FIG. 4 is a block diagram of a computing environment including the secure peripheral switching device of any of FIGS. 1, 2, 3A, and 3B, in accordance with an example of the present disclosure.

FIG. 5 is a block diagram of the KVM host selector of FIG. 4, in accordance with an example of the present disclosure.

FIG. 6 illustrates a front view of a chassis with the peripheral switching device of any of FIGS. 1, 2, 3A, and 3B installed therein, in accordance with an example of the present disclosure.

FIG. 7 is a schematic diagram of a computing system including the peripheral switching device of any of FIGS. 1, 2, 3A, 3B, 4, 5, and 6, in accordance with an example of the present disclosure.

Although the following detailed description will proceed with reference being made to illustrative examples, many alternatives, modifications, and variations thereof will be apparent in light of this disclosure.

### DETAILED DESCRIPTION

A peripheral sharing device is described. In an example, the peripheral sharing device includes an optical switch, a first signal interface, and a plurality of second signal interfaces. The first signal interface is coupled to the optical switch via a first optical fiber cable. The first signal interface is configured to be coupled to at least one peripheral device, such as a keyboard, pointing device, video display, or other peripheral device. A first one of the second signal interfaces is coupled to the optical switch via a second optical fiber cable. A second one of the second signal interfaces is coupled to the optical switch via a third optical fiber cable. The first one of the second signal interfaces is configured to be coupled to a first computing device, and the second one of the second signal interfaces is configured to be coupled to a second computing device. In some such examples, the optical switch is configured, in a first mode of operation, to optically couple the first signal interface to the first one of the second signal interfaces subsequent to optically decoupling the first signal interface from the second one of the second signal interfaces. The optical switch is further configured, in a second mode of operation, to optically couple the first signal interface to the second one of the second signal interfaces subsequent to optically decoupling the first signal interface from the first one of the second signal interfaces.

### Overview

As noted above, a peripheral sharing device allows a user to connect a single set of peripherals, such as a keyboard, pointing device, and video display, to multiple computers. Such peripheral sharing devices are useful, for example, in environments with limited workspace where the user wishes to access several different computing stations but lacks the space to install separate peripherals for each of the computers. Certain environments are subject to security requirements that prescribe the manner in which computers are installed and operated. For example, the security requirements may include: a first requirement that the peripheral sharing device must not permit unauthorized data to flow through the peripheral sharing device to any connected peripheral or computers; a second requirement that data must flow through the peripheral sharing device only to and from the intended connected computer; and a third requirement that only authorized peripheral devices can be connected to the computers through the peripheral sharing device. Such security requirements are difficult, if not impossible, to achieve using existing peripheral sharing device and techniques.

To this end, a peripheral switching device in accordance with an example can be used to switch a connection between one or more peripheral devices, such as a keyboard, mouse (or other user input device), and video display, and multiple host computers using an optical switch included in the peripheral switch device. The peripherals are connected to the peripheral switching device. The peripheral switching device is further connected to each of the host computers. The optical switch is configured to couple the peripheral devices to one host computer at a time and to isolate each of the host computers from each other. In some examples, the peripheral switch device is responsive to a switching function such that the peripheral switch device can be switched from one operation mode to another. For instance, in some example cases, a switching function (e.g., set of one or more buttons capable of generating one or more unique control signals) can be located on one of the peripheral devices, such as a keyboard or a dedicated mode selecting peripheral. In some such cases, the peripheral switch device may include a controller or processor configured to receive such control signals, and to control the optical switch to make the requisite connections between computers and peripherals. For example, a keyboard peripheral can include one or more designated keys that when pressed cause the peripheral switching device to switch peripheral control from one host computer to another. A user can thus securely switch the set of peripheral devices between any of the host computers, while also preventing unauthorized data flows or leakage between the host computers.

### Peripheral Switching Devices

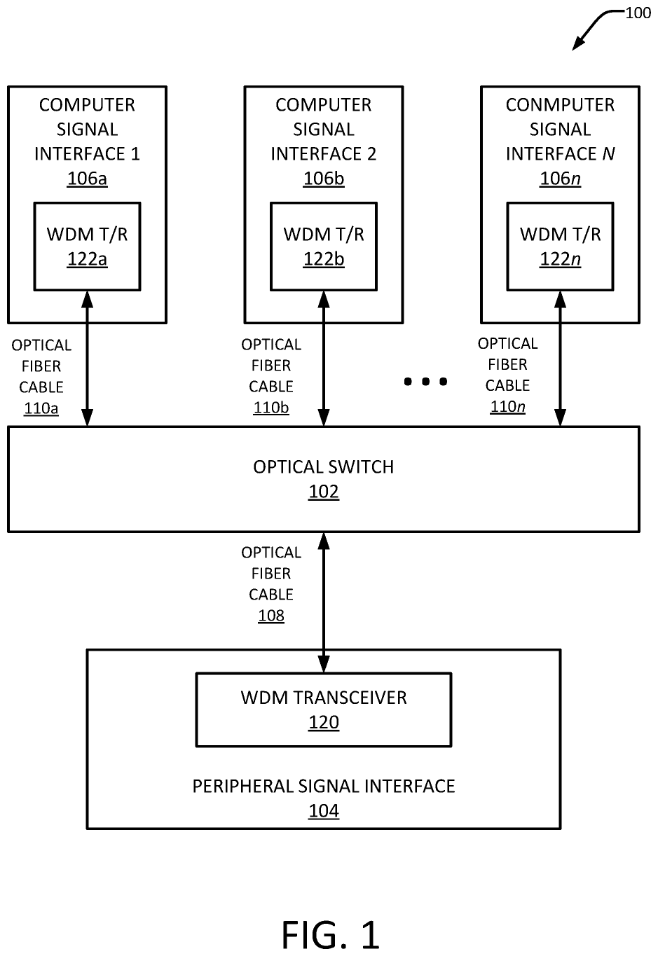

FIG. 1 is a block diagram of a peripheral switching device 100, in accordance with an example of the present disclosure. The peripheral switching device 100 includes an optical switch 102, a peripheral signal interface 104, and a plurality of computer signal interfaces 106a . . . n. The peripheral signal interface 104 is coupled to the optical switch 102 via a first optical fiber cable 108, where the first optical fiber cable 108 carries two fibers. Each of the computer signal interfaces 106a . . . n are coupled to the optical switch 102 via one or more second optical fiber cables 110a . . . n, where each of the second optical fiber cables 110a . . . n carries two fibers.

The first optical fiber cable 108 can include, for example, a first optical fiber i for transmitting signals from the peripheral signal interface 104 to the optical switch 102 (e.g., a Tx fiber) and a second optical fiber i+1 for transmitting signals from the optical switch 102 to the peripheral signal interface 104 (e.g., an Rx fiber), so as to provide bidirectional data communication via separate optical channels. For example, the peripheral signal interface 104 can include a wavelength division multiplexer (WDM) electrical/optical transceiver 120 configured to support bidirectional 40 Gbps throughput using two optical fibers i and i+1 (e.g., the first optical fiber cable 108). Such a configuration can provide sufficient bandwidth for up to two simultaneous 4K video streams, in addition to other device status and control data.

Similarly, each of the second optical fibers 110a . . . n can include, for example, a first optical fiber j for transmitting signals from the respective computer signal interface 106a . . . n to the optical switch 102 (e.g., a Tx fiber) and a second optical fiber j+1 for transmitting signals from the optical switch 102 to the respective computer signal interface 106a . . . n (e.g., an Rx fiber), so as to provide bidirectional data communication via separate optical channels. For example, each of the computer signal interfaces 106a . . . n can include a wavelength division multiplexer (WDM) electrical/optical transceiver 122a . . . n configured to support bidirectional 40 Gbps throughput using two optical fibers i and i+1 (e.g., the second optical fiber cable 108). Such a configuration can provide sufficient bandwidth for up to two simultaneous 4K video streams, in addition to other device status and control data. It will be understood that more than two optical fibers can be used to support bidirectional communication between the peripheral signal interface 104 and each of the computer signal interfaces 106a . . . n if the optical switch 102 is configured to support additional optical fiber connections, and that the present disclosure is not intended to limit the number of optical fibers to two, such as described above.

As will be described in further detail below, the optical switch 102 is configured to optically couple the peripheral signal interface 104 to one of the computer signal interfaces 106a . . . n via the first optical fiber cable 108 and one of the second optical fiber cables 110a . . . 110n such that the peripheral signal interface 104 and the coupled one of the computer signal interfaces 106a . . . n can exchange data with each other using optical communications. Note that in some examples the optical switch 102 is configured to couple the peripheral signal interface 104 to any one, but not more than one, of the computer signal interfaces 106a . . . n at a given time. The optical switch 102 facilitates switching between the computer signal interfaces 106a . . . n in a manner that isolates each of the computer signal interfaces 106a . . . n from each other so that communications between the peripheral signal interface 104 and the coupled computer signal interface 106a . . . n are secure and inaccessible by all of the other, uncoupled computer signal interfaces 106a . . . n. The optical switch 102 isolates the compute signal interfaces 106a . . . n from each other.

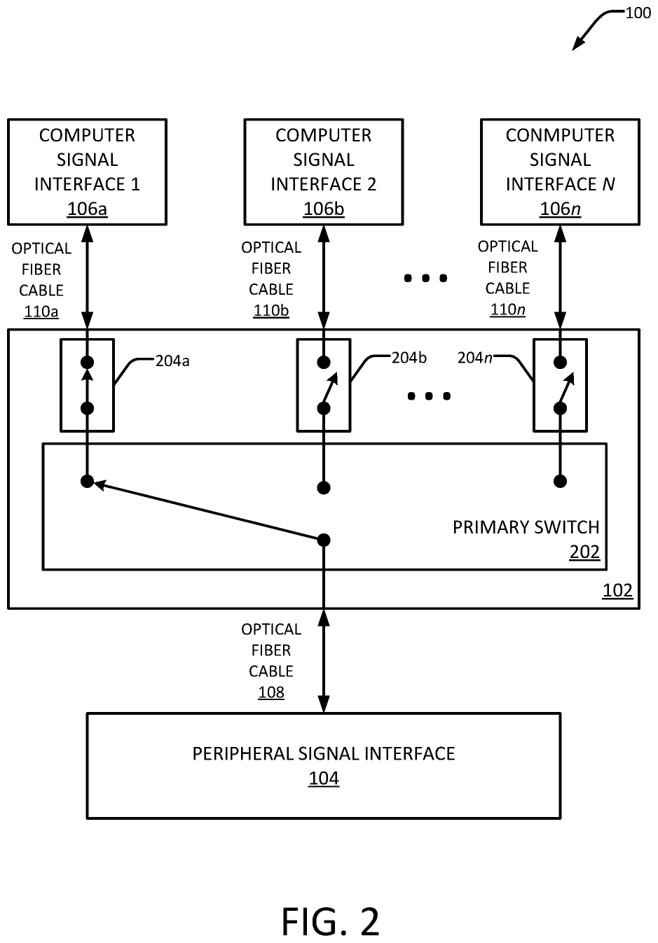

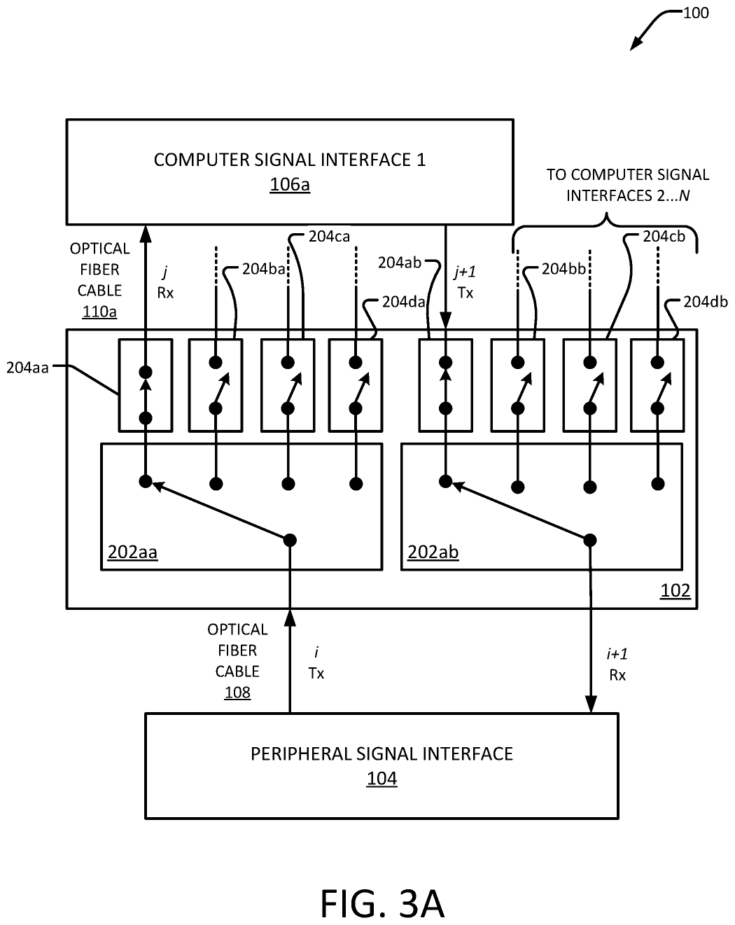

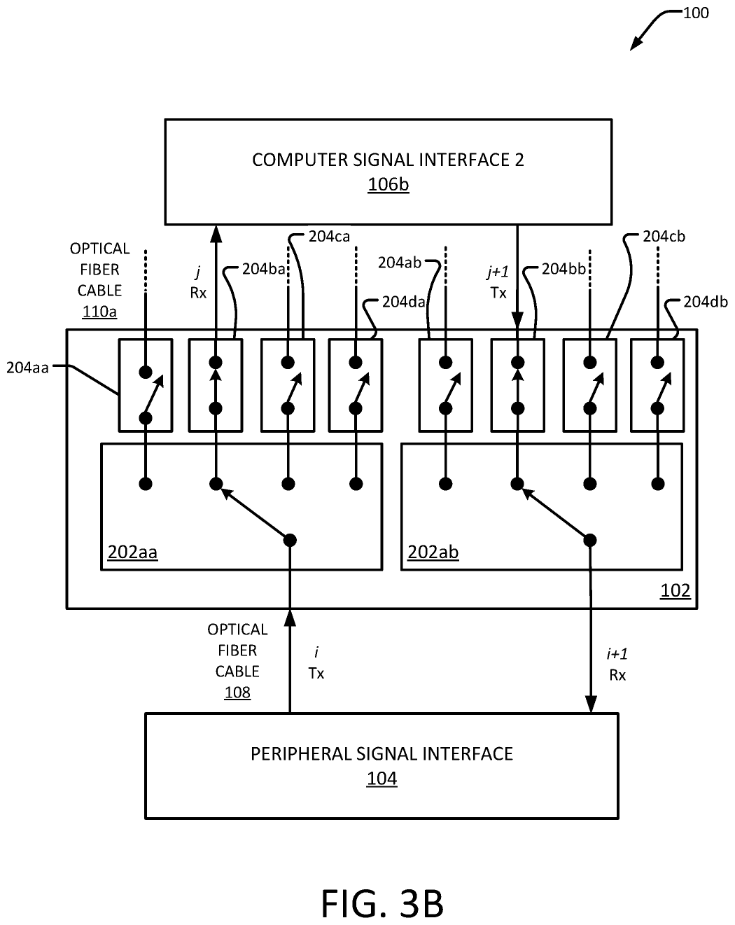

FIG. 2 is a block diagram of the peripheral switching device 100 of FIG. 1 in further detail, in accordance with an example of the present disclosure. The optical switch 102 includes one or more primary switches 202 (one shown for clarity) and one or more secondary switches 204a . . . n for coupling the first optical fiber cable 108 to the second optical fiber cables 110a . . . n. In some examples, separate primary switches 202 are provided for each fiber carried by the first optical fiber cable 108. In such examples, m primary switches 202 are provided for m fibers in the first optical fiber cable 108. Additionally, separate secondary switches 204a . . . n are provided for each fiber carried by each of the second optical fiber cables 110a . . . n to each of the computer signal interfaces 106a . . . n. In such examples, if there are n computer signal interfaces 106a . . . n and m fibers in each of the second optical fiber cables 110a . . . n, then n×m secondary switches 204a . . . n are provided in total, with m secondary switches 204a . . . n for each of the m fibers to each of the computer signal interfaces 106a . . . n. A further example is described below with respect to FIGS. 3A-B.

FIGS. 3A and 3B are block diagrams of the peripheral switching device 100 of FIG. 2 in further detail, in accordance with an example of the present disclosure. In this example, one of the m primary switches 202aa, where m=2, can be configured to optically couple a first fiber i of the m fibers carried by the first optical fiber cable 108 (e.g., a transmit channel with respect to the peripheral signal interface 104) to a first fiber i of the m fibers carried by one of the second optical fiber cables 110a . . . n (e.g., a receive channel with respect to one of the computer signal interfaces 106a . . . n). Similarly, another one of the m primary switches 202ab can be configured to optically couple a second fiber i+1 of the m fibers carried by the first optical fiber cable 108 (e.g., a receive channel with respect to the peripheral signal interface 104) to a first fiber i+1 of the m fibers carried by the second optical fibers 110a . . . n (e.g., a transmit channel). In other words, there are separate primary switches 202aa and 202ab for each of the m fibers carried by the first and second optical fiber cables 108, 110a . . . n. For example, if there is one first optical fiber cable 108 between the optical switch 102 and the peripheral signal interface 104, and two second optical fiber cables 110a, 110b between the optical switch 102 and the computer signal interfaces 106a, 106b, and each cable 108, 110a, 110b carries two fibers, then there are two primary switches 202aa, 202ab (one for each of the two fibers). In addition, two secondary switches 204aa and 204ab are provided for each of the two fibers, such as described in further detail below.

The optical switch 102 is configured to couple and decouple fibers using a break-before-make scheme. For example, the optical switch 102 can, in a first mode of operation, optically couple the peripheral signal interface 104 to a first computer signal interface 106a subsequent to optically decoupling the peripheral signal interface 104 from a second computer signal interface 106b. Further, the optical switch 102 can, in a second mode of operation, optically couple the peripheral signal interface 104 to the second computer signal interface 106b subsequent to optically decoupling the peripheral signal interface 104 from the first computer signal interface 106a. In this manner, the peripheral signal interface 104 is not optically coupled to more than one of the computer signal interfaces 106a, 106b simultaneously, which ensures that the computer signal interfaces 106a . . . n are isolated from each other at all times.

For example, referring first to FIG. 3A, one of the secondary switches 204aa is in series between the primary switch 202aa and the computer signal interface 106a, and another one of the secondary switches 204ab is in series between the primary switch 202ab and the computer signal interface 106a. While the optical switch 102 is in the first mode of operation, the secondary switch 202aa optically couples the first fiber i of the m fibers carried by one of the second optical fiber cables 110a . . . n to the primary switch 202aa, which in turn optically couples the first fiber i of the m fibers carried by the first optical fiber cable 108 to the peripheral signal interface 104. Similarly, the secondary switch 202ab optically couples the second fiber i+1 of the m fibers carried by one of the second optical fiber cables 110a . . . n to the primary switch 202aa, which in turn optically couples the second fiber i+1 of the m fibers carried by the first optical fiber cable 108 to the peripheral signal interface 104. Further, while the optical switch 102 is in the first mode of operation, the primary switches 202aa and 202ab and the secondary switches 204ba, 204bb, 204na, 204nb decouple all fibers that are coupled to other computer signal interfaces, such as computer signal interfaces 106b . . . n.

When the optical switch 102 transitions from the first mode of operation, such as shown in FIG. 3A, to the second mode of operation (e.g., the optical switch 102 decouples the first optical cable 108 from the computer signal interface 106a and couples the first optical cable 108 to the computer signal interface 106b), such as shown in FIG. 3B, the secondary switches 204aa and 204ab open. After the secondary switches 204aa and 204ab are opened, the primary switch 202aa switches from coupling the first optical fiber cable 108 to the second optical fiber cable 110a, to coupling the first optical fiber cable 108 to the second optical fiber cable 110b, and the secondary switches 204ba and 204bb close to complete the optical coupling between the peripheral signal interface 104 and the computer signal interface 106b, such as shown in FIG. 3B. Similar switching sequences are used to switch between other ones of the computer signal interfaces 106a . . . n.

### Computing Environment

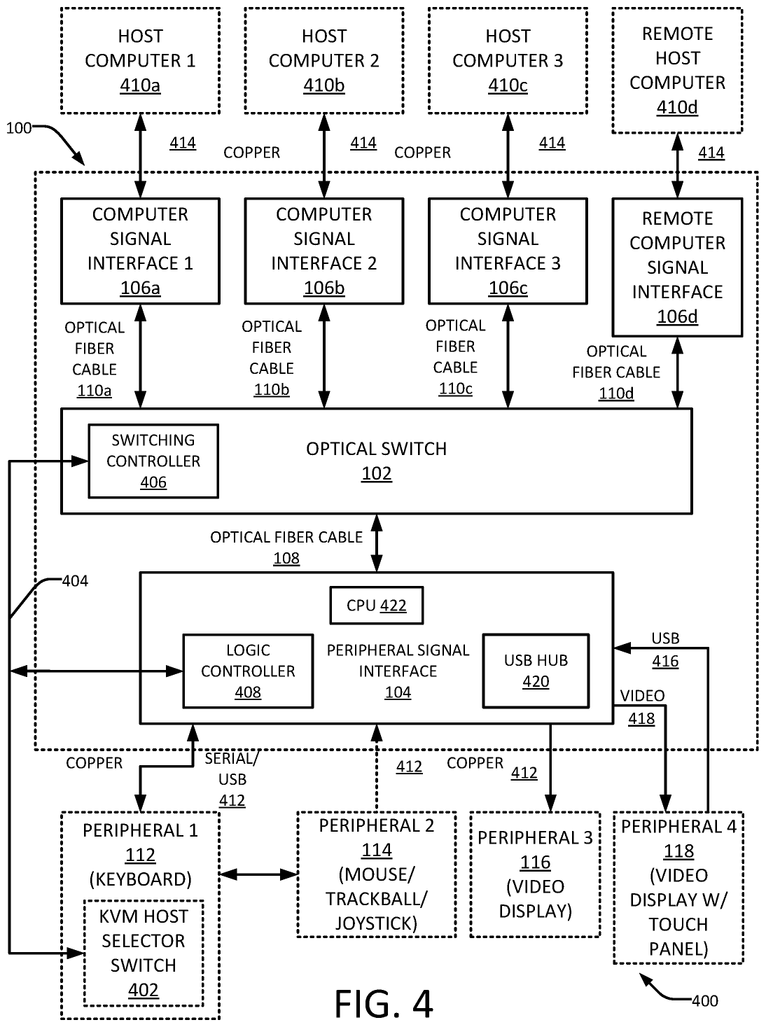

FIG. 4 is a block diagram of a computing environment 400 including the secure peripheral switching device 100 of FIG. 1, in accordance with an example of the present disclosure. The computing environment 400 further includes at least one peripheral device and a plurality of host computers 410a . . . n. In some examples, at least one of the host computers 410d is a remote host computer. The peripheral signal interface 104 is configured to be coupled to at least one peripheral device, including at least one user input device, such as a keyboard 112, a pointing device 114 (e.g., a mouse, trackpad, trackball, joystick, etc.), or other input device, and at least one display device, such as a video display 116, a video display with a touch panel 118 overlay, or other output device. Connection media 412 between the peripheral signal interface 104 and any of the peripheral devices 112, 114, 116 can include copper wire or another electrically conductive medium. The computer signal interfaces 106a . . . 106n are each configured to be coupled to a respective host computer 410a . . . n. For example, a first computer signal interface 106a is coupled to a first host computer 410a, a second computer signal interface 106b is coupled to a second host computer 410b, a third computer signal interface 106c is coupled to a third host computer 410c, and a remote computer signal interface 106d is coupled to the remote host computer 410d. Connection media 414 between each of the computer signal interfaces 106a . . . 106n and the respective host computer 410a . . . n can include copper wire or another electrically conductive medium. In some examples, copper connections can be used to provide serial communications, Universal Serial Bus (USB) communications including, for example, A, B, C, Mini-A, Mini-B, Micro-A, Micro-B, or other types of interfaces that support USB 1.1, 2.0, 3.0 standards), or other types of data communications between the peripheral devices 112, 114, 116 and the peripheral signal interface 104.

The peripheral signal interface 104 is configured to convert signals, including data and video signals, from the first optical fiber cable 108 to the connection media 412. Each of the computer signal interfaces 106a . . . n is configured to convert signals, including data and video signals, from the second optical fiber cables 110a . . . n to the respective connection media 414.

In some examples, one of the peripherals devices, such as the keyboard 112, can provide a communication hub for one or more other peripheral devices, such as the pointing device 114. For example, the keyboard 112 can include a USB hub to which the pointing device 114 is connected, and the USB hub in the keyboard 112 relays data from the pointing device 114 to the peripheral signal interface 104 via a serial and/or a USB connection. In this manner, each of the input peripheral devices 112 and 114 are switched together. In some other examples, multiple peripheral devices can be directly connected to the peripheral signal interface 104 via, e.g., serial, or USB connections.

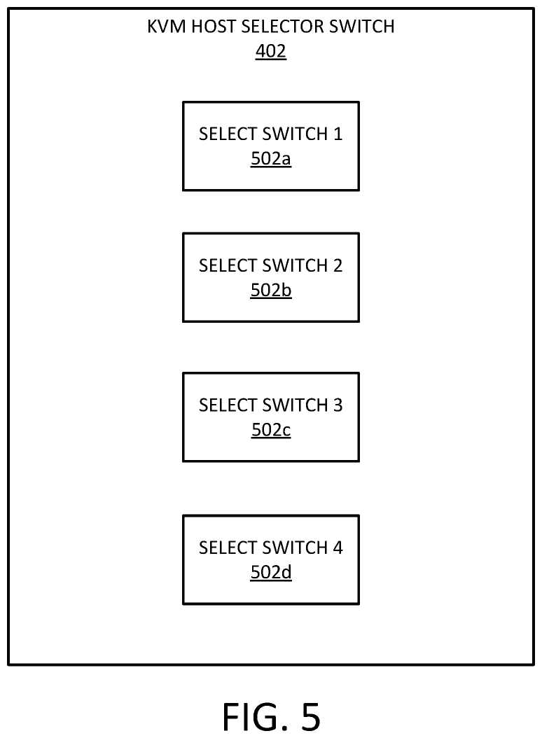

In some examples, one of the peripheral devices, such as the keyboard 112, includes a KVM host selector 402. FIG. 5 is a block diagram of the KVM host selector 402 of FIG. 4, in accordance with an example of the present disclosure. The KVM host selector 402 includes one or more select switches 502a, 502b, 502c, etc., that when pressed cause the peripheral switching device 100 to switch peripheral control from one host computer to another. For example, the KVM host selector 402 can include n keys or switches (e.g., 502a, 502b, 502c, 502d, etc.) that when pressed by a user causes the KVM host selector 402 to send a signal 404 to a switching controller 406 in the optical switch 102 and a logic controller 408, such as shown in FIG. 4. The KVM host selector 402 is connected (e.g., directly wired) to the switching controller 406 through a dedicated channel (e.g., a serial bus) that is separate from the serial/USB channels 412 used to connect the peripheral devices 112, 114, 116 to the peripheral signal interface 104. The signal 404 causes the optical switch 102 to couple one of the computer signal interfaces 106a . . . n to the peripheral signal interface 104 according to the key pressed. For example, the signal 404 can cause the optical switch to change from the first mode of operation to the second mode of operation, or vice versa. In some examples, each of the select switches 502a, 502b, 502c, etc., includes an indicator lamp that illuminates to identify which one of the computer signal interfaces 106a . . . n are actively coupled to the respective host computer 410a . . . n. Note that, in some embodiments, each of the switches 502a, 502b, 502c, etc. may generate a unique signal 404, which in turn allows controller 406 to control the mode of operation of the optical switch 102 (e.g., each unique signal 404 corresponds to a particular mode of operation).

Referring again to FIG. 4, in some examples, one or more of the peripheral devices 112, 114, 116 is assigned one or more unique identification codes that are communicated to the logic controller 408 of the peripheral signal interface 104. The logic controller 408 contains a user non-modifiable whitelist of the identification codes for each of the peripheral devices 112, 114, 116. Whitelisted devices are devices authorized for communicating with the host computers 410a . . . n via the peripheral signal interface 104. If the identification code of the peripheral device 112, 114, 116 is on the whitelist, the logic controller 408 enables the corresponding serial/USB port(s) on the peripheral signal interface 104 for the corresponding peripheral devices 112, 114, 116. Data received from the whitelisted peripheral devices is emulated by the serial peripheral interface 104 and sent to the host computer 410a . . . n selected by the switching controller 406. This allows the peripheral device 112, 114, 116 to communicate with the selected host computer 104a . . . n without being directly connected to the host computer. If the identification code of an attached peripheral is not on the whitelist, the logic controller 408 disables the associated serial/USB port(s) of the peripheral signal interface 104 to prevent the unauthorized peripheral device from communicating with any of the host computers 410a . . . n. This prevents data from being written to, and displayed at, an unauthorized peripheral device.

Each of the computer signal interfaces 106a . . . n are assigned a unique unit code (e.g., 0, 1, 2, 3, etc.) that is used by the peripheral signal interface 104 to verify that the peripheral signal interface 104 is connected to the correct computer signal interface 106a . . . n as selected by the user. The optical switch 102 utilizes a fiber optic communication protocol for transferring user data between the peripheral signal interface 104 and the selected computer signal interface 106a . . . n. The unit code of the respective computer signal interface 106a . . . n is encoded into the protocol to enable the peripheral signal interface 104 to verify that the correct computer signal interface 106a . . . n is connected. More specifically, the unit code is part of an encoded message. The message can include, for example, a 32-bit preamble (synchronization field), followed by 7 payload bits (Scroll Lock bit, Caps Lock bit, USB Status bit, 1 Tx fault bit, 3 bits of unit code), followed by a CRC (Cyclic Redundancy Check) and one reserved bit (set to zero).

The optical switch 102 controls all data flows between the host computers and the user peripherals. When a user switches the peripheral switching device 100 to a different host computer using the host selection controls, the unit code of the selected computer signal interface 106a . . . n corresponding to the selected host computer is sent to a switching controller in the optical switch 102 and to a logic controller in the peripheral signal interface 104. The optical switch 102 uses the unit code to connect to the port associated with the desired computer signal interface 106a . . . n, which in turn is connected to a corresponding host computer. The peripheral signal interface 104 uses the unit code to verify that the optical switch 102 has connected to the correct computer signal interface 106a . . . n. If this check fails, the peripheral signal interface 104 sends a fault message to a corresponding fault indicator on the keyboard and a message to the respective computer signal interface 106a . . . n to disable itself. The computer signal interface 104 further disables the USB ports and turns off the fiber optic transceiver laser to the respective computer signal interface 106a . . . n, which brings down the link between the computer signal interface 106a . . . n and the peripheral signal interface 104 so no data can pass between them in either direction. This ensures that the peripheral signal interface 104 will only communicate with the authorized computer signal interface 106a . . . n that is associated with the intended port.

In some examples, the peripheral switching device 100 includes the touch panel 118, such as shown in FIG. 4. The touch panel 118 can be in addition to the video display 116, which does not support a user input. The touch panel 118 is coupled to the peripheral signal interface 104 via an RS-232 to USB converter that outputs the RS-232 touch panel messages to the peripheral signal interface 104 using a USB cable 416. This communication channel is physically separate from the video (e.g., DisplayPort) communication channel 418 with a separate cable. The touch panel 118 USB port connects to a USB hub 420 in the peripheral signal interface 104 that also services the keyboard 112 and mouse/trackball 114 USB data. An upstream port of the USB hub 420 connects to an embedded CPU 422 in the peripheral signal interface 104 which acts as a USB host for all of the peripherals 112, 114, 116, 118 that are attached to the peripheral signal interface 104 so that the peripherals are not directly connected to any of the host computers 410a . . . d. The CPU 422 converts the RS-232 serial-over-USB data received from the touch panel 118 into USB human interface devices (HID) data, which the CPU 420 forwards to the logic controller 408. The logic controller 408 converts data into a format suitable for the fiber optic interface between the peripheral signal interface 104 and the host computers 410a . . . d. The data is then passed through the fiber optic interface to FPGA programmable logic in the computer signal interface 106a . . . d selected by the user, where it is converted back for use by an embedded CPU.

The CPU in the computer signal interface 106a . . . d then sends the data to the host computer 104a . . . d as normal USB data. The CPU in the computer signal interface 106a . . . d acts as an emulator to simulate a direct communication between the host computer 104a . . . d and the peripheral devices 112, 114, 116, 118 although there is no actual direct connection. Note that the USB data flow is unidirectional through the peripheral switching device 100 from the peripheral devices 112, 114, 117, 118 upstream to the host computers 410a . . . d. The USB connection between the host computer 410a . . . d and the computer signal interface 106a . . . d is bidirectional but only to the extent that the host computer 410a . . . d can enumerate the composite USB device in the computer signal interface 106a . . . d. Similarly, the USB connection between the peripheral signal interface 104 and the touch panel 118 and the other peripherals 112, 114, 116 is bidirectional but only to the extent that the peripheral signal interface 104 can enumerate the peripherals. The USB data flow within the peripheral switching device 100 is unidirectional from the peripheral signal interface 104 to the computer signal interface 106a . . . d.

### Mechanical Design

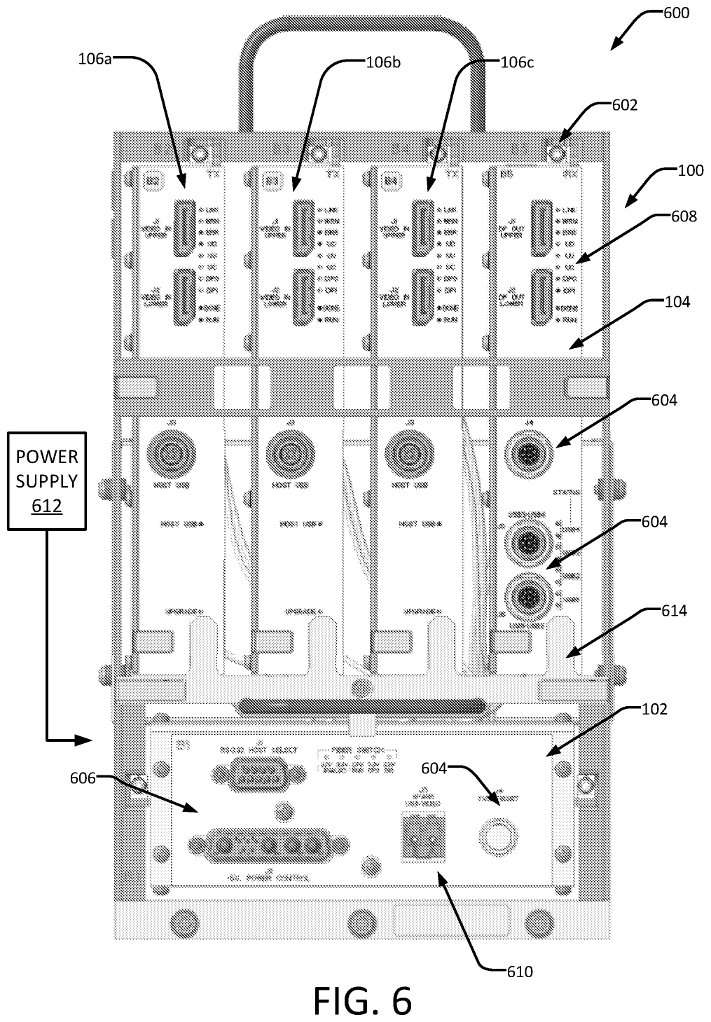

FIG. 6 is a schematic diagram of a front view of an apparatus including the peripheral switching device 100 of FIG. 1 installed therein, in accordance with an example of the present disclosure. In some examples, the peripheral switching device 100 is mounted in a chassis 600 and is cooled using a combination of conduction and convection cooling. Various components of the peripheral switch device 100, including the peripheral signal interface 104, the optical switch 102, and the computer signal interfaces 106a . . . n, can be conduction cooled via wedge locks 602 and are spaced apart to provide additional cooling air flow over their top and bottom surfaces. For example, the wedge locks 602 are configured to secure the components of the peripheral switching device 100 to the chassis 600. Each of the wedge locks 602 includes a thermally conductive material such as brass, copper, aluminum, etc., that facilitates the transfer of heat from each of the peripheral signal interface 104, the optical switch 102, and the computer signal interfaces 106a . . . n to the chassis 600. In some examples, to achieve certain operating and endurance vibration requirements, the peripheral switching device 100 includes latching circular push-pull connectors 604 for attaching the various components to the chassis 600. In some examples, the peripheral switching device 100 includes electromagnetic interference (EMI) shielded quick-connect back shells for D-Sub connectors 606. In some examples, the video interfaces use DVI, DisplayPort, and/or HDMI connectors 608. In some examples, the optical switch 102 includes a fiber optic input/output interface 610 for connecting additional computer signal interfaces 106a . . . n.

In some examples, the chassis 600 includes one or more anti-tamper members 614 configured to prevent access to at least one of the wedge locks 602. For example, the anti-tamper member 614 can include a rigid (e.g., metal) bracket that is secured to the chassis 600 and covers the wedge locks 602 so that the wedge locks 602 are inaccessible and cannot be released. In some examples, the anti-tamper member 614 can be arranged to prevent removal of the various components of the peripheral switching device 100, including the peripheral signal interface 104, the optical switch 102, and the computer signal interfaces 106a . . . n.

In some examples, the chassis 600 includes a power supply 612 for supplying power to any of the installed components, such as the peripheral signal interface 104, the optical switch 102, and the computer signal interfaces 106a . . . n. The power supply 612 can include, for example, a 5-volt DC power source. In some examples, the chassis 600 further includes a power distribution board (not shown) for distributing power from the power supply 612 to the various installed components, such as the peripheral signal interface 104, the optical switch 102, and the computer signal interfaces 106a . . . n.

In some examples, one or more of the peripherals 112, 114, 116 can be connected to the peripheral switching device 100 using non-standard RS-232 connectors. One such interface can connect, for example, the keyboard 112 to the peripheral signal interface 104 using a non-standard, push-pull type connector. Another such interface can connect the keyboard 112 to the optical switch 112 using a DB-9 connector with a non-standard pinout via a unidirectional (e.g., transmit only) RS-232 interface.

In some examples, the peripheral switching device 100 can include one or more USB connectors for connecting input/output devices, such as a touch panel, video displays, keyboards, trackballs, mice, or other peripherals. Each of the host computers 410a . . . n can output, for example, HDMI or DVI-D video signals using a DisplayPort dual mode feature provided by a graphics card installed in the respective host computer. The peripheral switching device 100 can signal the graphics card over the DisplayPort cable to activate the dual mode feature.

In some examples, the peripheral switching device 100 facilitates the switching of peripherals, including a local keyboard, trackball, and two displays (one of which can be a touch panel), to three local host computers and one remote host computer. The peripherals can be switched using host switch selector buttons on the keyboard, the buttons being wired to the peripheral switching device 100 separately from the keyboard USB connection. Where one of the displays is a touch panel, the display provides both input and output, where the input is treated as mouse data and the output is treated as video data.

In some examples, all peripheral (e.g., keyboard, trackball, touch panel) data connections are filtered by the peripheral switching device 100 and only data from authorized devices are routed through to the selected host computer. As noted above, the peripheral switching device 100 emulates data from the authorized USB peripherals to the selected host computer, so the peripherals are not in direct communication with the host computer. Furthermore, there are no data channels from the monitors (except a touch panel) to the host computer. This ensures that there is no data leakage from the peripheral outputs to the selected host computer and no unauthorized data flows from the monitor to the selected host computer.

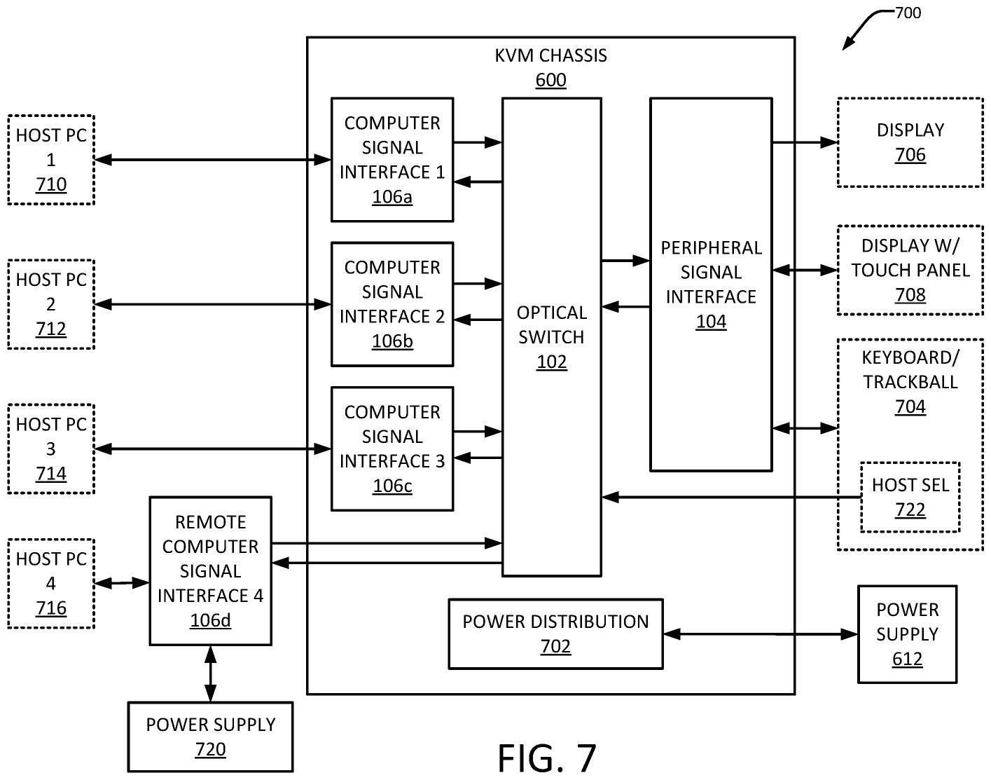

FIG. 7 is a schematic diagram of a computing system 700, in accordance with an example of the present disclosure. The system 700 includes the chassis 600 of FIG. 6, with the optical switch 102, the peripheral signal interface 104, and the computer signal interfaces 106a . . . c. The chassis 600 further includes a power distribution board 702 for distributing power from the power supply 612 to the optical switch 102, the peripheral signal interface 104, and the computer signal interfaces 106a . . . c. In some examples, the system further includes the remote computer signal interface 106d, which is located outside of the chassis 600 and is powered by a separate power supply 720.

As described above, each of the computer signal interfaces 106a . . . d has similar or identical hardware and software; however, each is configured with its own unique unit code (0, 1, 2 or 3) that is used by the peripheral signal interface 104 to verify that it is connected to the correct computer signal interface 106a . . . d. Each computer signal interface 106a . . . d interfaces to a separate host computer 710, 712, 714, 716 with dual video interfaces, one each for two separate monitors, and one USB interface. The external interfaces for the computer signal interface 106a . . . d interfaces and the peripheral signal interface 104 are copper, and the internal interface that connects the computer signal interface 106a . . . d and the peripheral signal interface 104 is fiber optic to provide isolation. The optical switch 102 connection between the computer signal interface 106a . . . d and the peripheral signal interface 104 allows the peripheral signal interface 104 to be connected to one of the computer signal interfaces 106a . . . d at a time. The peripheral signal interface 104 connects to the downstream peripheral devices, including a keyboard/trackball 704, a display 706, and a display with a touch panel overlay 708. The user can select which computer signal interface 106a . . . d is connected to the peripheral signal interface 104 using a host selector on a remote controller part of the keyboard 704. The selection information goes from the remote controller part of the keyboard 704 to the peripheral signal interface 104 and the optical switch 102 via two RS-232 interfaces: one to the peripheral signal interface 104 and one to the optical switch 102. The optical switch 102 RS-232 interface is unidirectional, but the peripheral signal interface 104 RS-232 interface is bidirectional, providing KVM status and CAPS Lock and Scroll Lock LED indicator information to the keyboard. The host selector 722 and RS-232 interfaces are separate from the keyboard USB interfaces. This allows for unidirectionality to be maintained for the USB keyboard interface, as the RS-232 interface is a separate data path that is used for the remote-control portion of the keyboard. The power distribution board 702 accepts +5VDC power and distributes it to the individual KVM modules.

### Further Examples

The following examples pertain to further examples, from which numerous permutations and configurations will be apparent.

Example 1 provides a peripheral sharing device comprising an optical switch; a first signal interface coupled to the optical switch via a first optical fiber cable, the first signal interface configured to be coupled to at least one peripheral device; and a plurality of second signal interfaces, a first one of the plurality of second signal interfaces coupled to the optical switch via a second optical fiber cable, a second one of the plurality of second signal interfaces coupled to the optical switch via a third optical fiber cable, the first one of the plurality of second signal interfaces configured to be coupled to a first computing device, the second one of the plurality of second signal interfaces configured to be coupled to a second computing device.

Example 2 includes the subject matter of Example 1, wherein the optical switch is configured, in a first mode of operation, to optically couple the first signal interface to the first one of the plurality of second signal interfaces subsequent to optically decoupling the first signal interface from the second one of the plurality of second signal interfaces, and in a second mode of operation, to optically couple the first signal interface to the second one of the plurality of second signal interfaces subsequent to optically decoupling the first signal interface from the first one of the plurality of second signal interfaces.

Example 3 includes the subject matter of Example 2, further comprising a switching control unit configured to receive a control signal from the at least one peripheral device, the switching control unit configured to cause the optical switch to switch between the first mode of operation and the second mode of operation in response to receiving the control signal.

Example 4 includes the subject matter of any one of Examples 1-3, wherein the first one of the plurality of second signal interfaces is optically isolated from the second one of the plurality of second signal interfaces.

Example 5 includes the subject matter of any one of Examples 1-4, wherein the at least one peripheral device includes at least one user input device and at least one display device.

Example 6 includes the subject matter of any one of Examples 1-5, further comprising at least one electrically conductive medium coupled to the first signal interface, at least one of the plurality of second signal interfaces, or both.

Example 7 includes the subject matter of any one of Examples 1-6, further comprising the at least one peripheral device coupled to the first signal interface, the first computing device coupled to a first one of the plurality of second signal interfaces, and the second computing device coupled to a second one of the plurality of second signal interfaces.

Example 8 includes the subject matter of any one of Examples 1-7, further comprising a first optical fiber cable coupled to the optical switch and a second optical fiber cable coupled to the optical switch, the first optical fiber cable including a first optical fiber i for transmitting signals from the first signal interface to the optical switch and a second optical fiber i+1 for transmitting signals from the optical switch to the first signal interface, the second optical fiber cable including a third optical fiber j for transmitting signals from the optical switch to at least one of the second signal interfaces and a fourth optical fiber j+1 for transmitting signals from the second signal interface to the optical switch.

Example 9 provides an apparatus comprising a chassis; and the peripheral sharing device of any one of Examples 1-8 mounted in the chassis.

Example 10 provides a peripheral sharing device comprising an optical switch; a first signal interface coupled to the optical switch and at least one peripheral device; and a plurality of second signal interfaces, a first one of the plurality of second signal interfaces coupled to the optical switch and a first computing device, a second one of the plurality of second signal interfaces coupled to the optical switch and a second computing device, wherein the optical switch is configured, in a first mode of operation, to optically couple the first signal interface to the first one of the plurality of second signal interfaces subsequent to optically decoupling the first signal interface from the second one of the plurality of second signal interfaces, and in a second mode of operation, to optically couple the first signal interface to the second one of the plurality of second signal interfaces subsequent to optically decoupling the first signal interface from the first one of the plurality of second signal interfaces.

Example 11 includes the subject matter of Example 10, wherein the first signal interface is coupled to the optical switch via a first optical fiber cable, wherein a first one of the plurality of second signal interfaces is coupled to the optical switch via a second optical fiber cable, and wherein a second one of the plurality of second signal interfaces is coupled to the optical switch via a third optical fiber cable.

Example 12 includes the subject matter of any one of Examples 10 and 11, further comprising a switching control unit configured to receive a control signal from the at least one peripheral device, the switching control unit configured to cause the optical switch to switch between the first mode of operation and the second mode of operation in response to receiving the control signal.

Example 13 includes the subject matter of any one of Examples 10-12, wherein the first one of the plurality of second signal interfaces is optically isolated from the second one of the plurality of second signal interfaces.

Example 14 includes the subject matter of any one of Examples 10-13, wherein the at least one peripheral device includes at least one user input device and at least one display device.

Example 15 includes the subject matter of any one of Examples 10-14, further comprising at least one electrically conductive medium coupled to the first signal interface, at least one of the plurality of second signal interfaces, or both.

Example 16 includes the subject matter of any one of Examples 10-15, further comprising a first optical fiber cable coupled to the optical switch and a second optical fiber cable coupled to the optical switch, the first optical fiber cable including a first optical fiber i for transmitting signals from the first signal interface to the optical switch and a second optical fiber i+1 for transmitting signals from the optical switch to the first signal interface, the second optical fiber cable including a third optical fiber j for transmitting signals from the optical switch to at least one of the second signal interfaces and a fourth optical fiber j+1 for transmitting signals from the second signal interface to the optical switch.

Example 17 includes the subject matter of any one of Examples 10-16, wherein the at least one peripheral device includes a switch including a plurality of keys, the switch configured to send a signal to a switching controller in the optical switch in response to a user activation of at least one of the keys, and wherein the switching controller is configured to cause the optical switch to change from the first mode of operation to the second mode of operation.

Example 18 provides an apparatus comprising a chassis; an optical switch mounted in the chassis; a first signal interface mounted in the chassis, the first signal interface coupled to the optical switch via a first optical fiber cable, the first signal interface configured to be coupled to at least one peripheral device; and a plurality of second signal interfaces mounted in the chassis, a first one of the plurality of second signal interfaces coupled to the optical switch via a second optical fiber cable, a second one of the plurality of second signal interfaces coupled to the optical switch via a third optical fiber cable, the first one of the plurality of second signal interfaces configured to be coupled to a first computing device, the second one of the plurality of second signal interfaces configured to be coupled to a second computing device.

Example 19 includes the subject matter of Example 18, further comprising at least one wedge lock configured to secure the first signal interface, at least one of the plurality of second signal interfaces, or both to the chassis, wherein the at least one wedge lock includes a thermally conductive material.

Example 20 includes the subject matter of Example 19, further comprising at least one anti-tamper member configured to prevent access to the at least one wedge lock.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the peripheral sharing device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A peripheral sharing device comprising:
an optical switch;
a first signal interface coupled to the optical switch via a first optical fiber cable, the first signal interface configured to be coupled to at least one peripheral device; and
a plurality of second signal interfaces, a first one of the plurality of second signal interfaces coupled to the optical switch via a second optical fiber cable, a second one of the plurality of second signal interfaces coupled to the optical switch via a third optical fiber cable, the first one of the plurality of second signal interfaces configured to be coupled to a first computing device, the second one of the plurality of second signal interfaces configured to be coupled to a second computing device.

2. The peripheral sharing device of claim 1, wherein the optical switch is configured, in a first mode of operation, to optically couple the first signal interface to the first one of the plurality of second signal interfaces subsequent to optically decoupling the first signal interface from the second one of the plurality of second signal interfaces, and in a second mode of operation, to optically couple the first signal interface to the second one of the plurality of second signal interfaces subsequent to optically decoupling the first signal interface from the first one of the plurality of second signal interfaces.

3. The peripheral sharing device of claim 2, further comprising a switching control unit configured to receive a control signal from the at least one peripheral device, the switching control unit configured to cause the optical switch to switch between the first mode of operation and the second mode of operation in response to receiving the control signal.

4. The peripheral sharing device of claim 1, wherein the first one of the plurality of second signal interfaces is optically isolated from the second one of the plurality of second signal interfaces.

5. The peripheral sharing device of claim 1, wherein the at least one peripheral device includes at least one user input device and at least one display device.

6. The peripheral sharing device of claim 1, further comprising at least one electrically conductive medium coupled to the first signal interface, at least one of the plurality of second signal interfaces, or both.

7. The peripheral sharing device of claim 1, further comprising the at least one peripheral device coupled to the first signal interface, the first computing device coupled to a first one of the plurality of second signal interfaces, and the second computing device coupled to a second one of the plurality of second signal interfaces.

8. The peripheral sharing device of claim 1, further comprising a first optical fiber cable coupled to the optical switch and a second optical fiber cable coupled to the optical switch, the first optical fiber cable including a first optical fiber i for transmitting signals from the first signal interface to the optical switch and a second optical fiber i+1 for transmitting signals from the optical switch to the first signal interface, the second optical fiber cable including a third optical fiber j for transmitting signals from the optical switch to at least one of the second signal interfaces and a fourth optical fiber j+1 for transmitting signals from the second signal interface to the optical switch.

9. An apparatus comprising:
a chassis; and
the peripheral sharing device of claim 1 mounted in the chassis.

10. A peripheral sharing device comprising:
an optical switch;
a first signal interface coupled to the optical switch and at least one peripheral device; and
a plurality of second signal interfaces, a first one of the plurality of second signal interfaces coupled to the optical switch and a first computing device, a second one of the plurality of second signal interfaces coupled to the optical switch and a second computing device,
wherein the optical switch is configured, in a first mode of operation, to optically couple the first signal interface to the first one of the plurality of second signal interfaces subsequent to optically decoupling the first signal interface from the second one of the plurality of second signal interfaces, and in a second mode of operation, to optically couple the first signal interface to the second one of the plurality of second signal interfaces subsequent to optically decoupling the first signal interface from the first one of the plurality of second signal interfaces.

11. The peripheral sharing device of claim 10, wherein the first signal interface is coupled to the optical switch via a first optical fiber cable, wherein a first one of the plurality of second signal interfaces is coupled to the optical switch via a second optical fiber cable, and wherein a second one of the plurality of second signal interfaces is coupled to the optical switch via a third optical fiber cable.

12. The peripheral sharing device of claim 10, further comprising a switching control unit configured to receive a control signal from the at least one peripheral device, the switching control unit configured to cause the optical switch to switch between the first mode of operation and the second mode of operation in response to receiving the control signal.

13. The peripheral sharing device of claim 10, wherein the first one of the plurality of second signal interfaces is optically isolated from the second one of the plurality of second signal interfaces.

14. The peripheral sharing device of claim 10, wherein the at least one peripheral device includes at least one user input device and at least one display device.

15. The peripheral sharing device of claim 10, further comprising at least one electrically conductive medium coupled to the first signal interface, at least one of the plurality of second signal interfaces, or both.

16. The peripheral sharing device of claim 10, further comprising a first optical fiber cable coupled to the optical switch and a second optical fiber cable coupled to the optical switch, the first optical fiber cable including a first optical fiber i for transmitting signals from the first signal interface to the optical switch and a second optical fiber i+1 for transmitting signals from the optical switch to the first signal interface, the second optical fiber cable including a third optical fiber j for transmitting signals from the optical switch to at least one of the second signal interfaces and a fourth optical fiber j+1 for transmitting signals from the second signal interface to the optical switch.

17. The peripheral sharing device of claim 10, wherein the at least one peripheral device includes a switch including a plurality of keys, the switch configured to send a signal to a switching controller in the optical switch in response to a user activation of at least one of the keys, and wherein the switching controller is configured to cause the optical switch to change from the first mode of operation to the second mode of operation.

18. An apparatus comprising:
a chassis;
an optical switch mounted in the chassis;
a first signal interface mounted in the chassis, the first signal interface coupled to the optical switch via a first optical fiber cable, the first signal interface configured to be coupled to at least one peripheral device; and
a plurality of second signal interfaces mounted in the chassis, a first one of the plurality of second signal interfaces coupled to the optical switch via a second optical fiber cable, a second one of the plurality of second signal interfaces coupled to the optical switch via a third optical fiber cable, the first one of the plurality of second signal interfaces configured to be coupled to a first computing device, the second one of the plurality of second signal interfaces configured to be coupled to a second computing device.

19. The apparatus of claim 18, further comprising at least one wedge lock configured to secure the first signal interface, at least one of the plurality of second signal interfaces, or both to the chassis, wherein the at least one wedge lock includes a thermally conductive material.

20. The apparatus of claim 19, further comprising at least one anti-tamper member configured to prevent access to the at least one wedge lock.
